(19) United States
(12) Patent Application Publication
(10) Pub. No.: US 2022/0122414 A1
(43) Pub. Date: Apr. 21, 2022

(54) METHOD FOR PERFORMING ANALYTICS ON A USER'S WAGERING HISTORY

(71) Applicant: AdrenalineIP, Washington, DC (US)

(72) Inventors: Casey Alexander HUKE, Washington, DC (US); John CRONIN, Jericho, VT (US); Joseph W. BEYERS, Saratoga, CA (US); Michael D'ANDREA, Burlington, VT (US)

(73) Assignee: AdrenalineIP, Washington, DC (US)

(21) Appl. No.: 17/375,342

(22) Filed: Jul. 14, 2021

Related U.S. Application Data
(60) Provisional application No. 63/094,518, filed on Oct. 21, 2020.

(51) Int. Cl. G07F 17/32

(52) U.S. Cl. CPC G07F 17/3237

(57) ABSTRACT

The present disclosure provides a method for performing analytics on a user's wagering history and performing analytics on users with similar characteristics of the user and displaying the percentages on a wagering application to inform the user of their success rate of wagering on similar wager markets as well as the success rate for users with similar characteristics of the user. The method groups users with similar characteristics into various cohorts, allowing the system to analyze the user's wagering history and users that are similar to the user and inform the user of the user's success rate and the cohort that the user is placed in.

### FIELD

The present embodiments are generally related to play-by-play wagering on live sporting events.

### BACKGROUND

Currently, an issue on wagering applications and wagering platforms is that a user is not informed of any statistical data based on their wagering history before confirming a wager.

Also, another issue on wagering applications and wagering platforms is that a user is not informed of any statistical data based on a similar user's wagering history before confirming a wager.

Lastly, the user's wagering history is not easily displayed on wagering applications. For example, while the user is in the process of placing a wager, the user is forced to look at their wagering history separately in a wagering application.

Thus, there is a need in the prior art to display and inform a user of their wagering history while still allowing the user to place wagers on the same interface or display screen.

### SUMMARY

Methods and systems for performing analytics on the wagering history of a user or group of users may be shown and described. In one embodiment, a method for performing analytics on wagering history of a user and a cohort on a wagering network can include grouping users into cohorts; storing a wagering history of at least one user and at least one cohort in at least one database; analyzing the wagering history of a user in the database; analyzing the wagering history of a cohort in the database; determining a historical wagering success rate of the user and the cohort; and displaying the success rate of the user and the cohort for a selected wager market on an application or device.

In another embodiment, a system for performing analytics on wagering history of a user and a cohort on a wagering network may be provided. The system can include a base wagering module configured to initiate at least one of a cohort module, a user analytics module, and a cohort analytics module; the cohort module configured to group users into a cohort; the user analytics module configured to analyze and display wagering history of a user; the cohort analytics module configured to analyze and display wagering history of a cohort; a user database configured to store at least one wagering history and cohort number of the user; a cohort database configured to store at least one cohort number and cohort requirement; and a device or application configured to display a notification.

### BRIEF DESCRIPTIONS OF THE DRAWINGS

The accompanying drawings illustrate various embodiments of systems, methods, and various other aspects of the embodiments. Any person with ordinary art skills will appreciate that the illustrated element boundaries (e.g., boxes, groups of boxes, or other shapes) in the figures represent an example of the boundaries. It may be understood that, in some examples, one element may be designed as multiple elements or that multiple elements may be designed as one element. In some examples, an element shown as an internal component of one element may be implemented as an external component in another and vice versa. Furthermore, elements may not be drawn to scale. Non-limiting and non-exhaustive descriptions are described with reference to the following drawings. The components in the figures are not necessarily to scale, emphasis instead being placed upon illustrating principles.

FIG. 1: illustrates a method for performing analytics on a user's wagering history, according to an embodiment.

FIG. 2: illustrates a base module, according to an embodiment.

FIG. 3: illustrates a cohort module, according to an embodiment.

FIG. 4: illustrates a user analytics module, according to an embodiment.

FIG. 5: illustrates a cohort analytics module, according to an embodiment.

FIG. 6: illustrates a cohort database, according to an embodiment.

### DETAILED DESCRIPTION

Aspects of the present invention are disclosed in the following description and related figures directed to specific embodiments of the invention. Those of ordinary skill in the art will recognize that alternate embodiments may be devised without departing from the spirit or the scope of the claims. Additionally, well-known elements of exemplary embodiments of the invention will not be described in detail or will be omitted so as not to obscure the relevant details of the invention.

As used herein, the word exemplary means serving as an example, instance or illustration. The embodiments described herein are not limiting, but rather are exemplary only. The described embodiments are not necessarily to be construed as preferred or advantageous over other embodiments. Moreover, the terms embodiments of the invention, embodiments, or invention do not require that all embodiments of the invention include the discussed feature, advantage, or mode of operation.

Further, many of the embodiments described herein are described in terms of sequences of actions to be performed by, for example, elements of a computing device. It should be recognized by those skilled in the art that specific circuits can perform the various sequence of actions described herein (e.g., application specific integrated circuits (ASICs)) and/or by program instructions executed by at least one processor. Additionally, the sequence of actions described herein can be embodied entirely within any form of computer-readable storage medium such that execution of the sequence of actions enables the processor to perform the functionality described herein. Thus, the various aspects of the present invention may be embodied in several different forms, all of which have been contemplated to be within the scope of the claimed subject matter. In addition, for each of the embodiments described herein, the corresponding form of any such embodiments may be described herein as, for example, a computer configured to perform the described action.

With respect to the embodiments, a summary of terminology used herein is provided.

An action refers to a specific play or specific movement in a sporting event. For example, an action may determine which players were involved during a sporting event. In some embodiments, an action may be a throw, shot, pass, swing, kick, and/or hit performed by a participant in a sporting event. In some embodiments, an action may be a strategic decision made by a participant in the sporting event, such as a player, coach, management, etc. In some embodiments, an action may be a penalty, foul, or other type of infraction occurring in a sporting event. In some embodiments, an action may include the participants of the sporting event. In some embodiments, an action may include beginning events of sporting event, for example opening tips, coin flips, opening pitch, national anthem singers, etc. In some embodiments, a sporting event may be football, hockey, basketball, baseball, golf, tennis, soccer, cricket, rugby, MMA, boxing, swimming, skiing, snowboarding, horse racing, car racing, boat racing, cycling, wrestling, Olympic sport, eSports, etc. Actions can be integrated into the embodiments in a variety of manners.

A “bet” or “wager” is to risk something, usually a sum of money, against someone else's or an entity based on the outcome of a future event, such as the results of a game or event. It may be understood that non-monetary items may be the subject of a “bet” or “wager” as well, such as points or anything else that can be quantified for a “bet” or “wager.” A bettor refers to a person who bets or wagers. A bettor may also be referred to as a user, client, or participant throughout the present invention. A “bet” or “wager” could be made for obtaining or risking a coupon or some enhancements to the sporting event, such as better seats, VIP treatment, etc. A “bet” or “wager” can be made for certain amount or for a future time. A “bet” or “wager” can be made for being able to answer a question correctly. A “bet” or “wager” can be made within a certain period. A “bet” or “wager” can be integrated into the embodiments in a variety of manners.

A “book” or “sportsbook” refers to a physical establishment that accepts bets on the outcome of sporting events. A “book” or “sportsbook” system enables a human working with a computer to interact, according to set of both implicit and explicit rules, in an electronically powered domain to place bets on the outcome of sporting event. An added game refers to an event not part of the typical menu of wagering offerings, often posted as an accommodation to patrons. A “book” or “sportsbook” can be integrated into the embodiments in a variety of manners.

To “buy points” means a player pays an additional price (more money) to receive a half-point or more in the player's favor on a point spread game. Buying points means you can move a point spread, for example, up to two points in your favor. “Buy points” can be integrated into the embodiments in a variety of manners.

The “price” refers to the odds or point spread of an event. To “take the price” means betting the underdog and receiving its advantage in the point spread. “Price” can be integrated into the embodiments in a variety of manners.

“No action” means a wager in which no money is lost or won, and the original bet amount is refunded. “No action” can be integrated into the embodiments in a variety of manners.

The “sides” are the two teams or individuals participating in an event: the underdog and the favorite. The term “favorite” refers to the team considered most likely to win an event or game. The “chalk” refers to a favorite, usually a heavy favorite. Bettors who like to bet big favorites are referred to “chalk eaters” (often a derogatory term). An event or game in which the sportsbook has reduced its betting limits, usually because of weather or the uncertain status of injured players, is referred to as a “circled game.” “Laying the points or price” means betting the favorite by giving up points. The term “dog” or “underdog” refers to the team perceived to be most likely to lose an event or game. A “longshot” also refers to a team perceived to be unlikely to win an event or game. “Sides,” “favorite,” “chalk,” “circled game,” “laying the points price,” “dog,” and “underdog” can be integrated into the embodiments in a variety of manners.

The “money line” refers to the odds expressed in terms of money. With money odds, whenever there is a minus (−), the player “lays” or is “laying” that amount to win (for example, $100); where there is a plus (+), the player wins that amount for every $100 wagered. A “straight bet” refers to an individual wager on a game or event that will be determined by a point spread or money line. The term “straight-up” means winning the game without any regard to the “point spread,” a “money-line” bet. “Money line,” “straight bet,” and “straight-up” can be integrated into the embodiments in a variety of manners.

The “line” refers to the current odds or point spread on a particular event or game. The “point spread” refers to the margin of points in which the favored team must win an event by to “cover the spread.” To “cover” means winning by more than the “point spread.” A handicap of the “point spread” value is given to the favorite team so bettors can choose sides at equal odds. “Cover the spread” means that a favorite wins an event with the handicap considered or the underdog wins with additional points. To “push” refers to when the event or game ends with no winner or loser for wagering purposes, a tie for wagering purposes. A “tie” is a wager in which no money is lost or won because the teams' scores were equal to the number of points in the given “point spread.” The “opening line” means the earliest line posted for a particular sporting event or game. The term “pick” or “pick 'em” refers to a game when neither team is favored in an event or game. “Line,” “cover the spread,” “cover,” “tie,” “pick,” and “pick-em” can be integrated into the embodiments in a variety of manners.

To “middle” means to win both sides of a game; wagering on the “underdog” at one point spread and the favorite at a different point spread and winning both sides. For example, if the player bets the underdog +4½ and the favorite −3½ and the favorite wins by 4, the player has middled the book and won both bets. “Middle” can be integrated into the embodiments in a variety of manners.

Digital gaming refers to any type of electronic environment that can be controlled or manipulated by a human user for entertainment purposes. A system that enables a human and a computer to interact according to set of both implicit and explicit rules in an electronically powered domain for the purpose of recreation or instruction. “eSports” refers to a form of sports competition using video games, or a multiplayer video game played competitively for spectators, typically by professional gamers. Digital gaming and “eSports” can be integrated into the embodiments in a variety of manners.

The term event refers to a form of play, sport, contest, or game, especially one played according to rules and decided by skill, strength, or luck. In some embodiments, an event may be football, hockey, basketball, baseball, golf, tennis, soccer, cricket, rugby, MMA, boxing, swimming, skiing, snowboarding, horse racing, car racing, boat racing, cycling, wrestling, Olympic sport, etc. The event can be integrated into the embodiments in a variety of manners.

The “total” is the combined number of runs, points or goals scored by both teams during the game, including overtime. The “over” refers to a sports bet in which the player wagers that the combined point total of two teams will be more than a specified total. The “under” refers to bets that the total points scored by two teams will be less than a certain figure. “Total,” “over,” and “under” can be integrated into the embodiments in a variety of manners.

A “parlay” is a single bet that links together two or more wagers; to win the bet, the player must win all the wagers in the “parlay.” If the player loses one wager, the player loses the entire bet. However, if they win all the wagers in the “parlay,” the player receives a higher payoff than if the player had placed the bets separately. A “round robin” is a series of parlays. A “teaser” is a type of parlay in which the point spread, or total of each individual play is adjusted. The price of moving the point spread (teasing) is lower payoff odds on winning wagers. “Parlay,” “round robin,” “teaser” can be integrated into the embodiments in a variety of manners.

A “prop bet” or “proposition bet” means a bet that focuses on the outcome of events within a given game. Props are often offered on marquee games of great interest. These include Sunday and Monday night pro football games, various high-profile college football games, major college bowl games, and playoff and championship games. An example of a prop bet is “Which team will score the first touchdown?” “Prop bet” or “proposition bet” can be integrated into the embodiments in a variety of manners.

A “first-half bet” refers to a bet placed on the score in the first half of the event only and only considers the first half of the game or event. The process in which you go about placing this bet is the same process that you would use to place a full game bet, but as previously mentioned, only the first half is important to a first-half bet type of wager. A “half-time bet” refers to a bet placed on scoring in the second half of a game or event only. “First-half-bet” and “half-time-bet” can be integrated into the embodiments in a variety of manners.

A “futures bet” or “future” refers to the odds that are posted well in advance on the winner of major events. Typical future bets are the Pro Football Championship, Collegiate Football Championship, the Pro Basketball Championship, the Collegiate Basketball Championship, and the Pro Baseball Championship. “Futures bet” or “future” can be integrated into the embodiments in a variety of manners.

The “listed pitchers” is specific to a baseball bet placed only if both pitchers scheduled to start a game start. If they do not, the bet is deemed “no action” and refunded. The “run line” in baseball refers to a spread used instead of the money line. “Listed pitchers,” “no action,” and “run line” can be integrated into the embodiments in a variety of manners.

The term “handle” refers to the total amount of bets taken. The term “hold” refers to the percentage the house wins. The term “juice” refers to the bookmaker's commission, most commonly the 11 to 10 bettors lay on straight point spread wagers: also known as “vigorish” or “vig”. The “limit” refers to the maximum amount accepted by the house before the odds and/or point spread are changed. “Off the board” refers to a game in which no bets are being accepted. “Handle,” “juice,” vigorish,” “vig,” and “off the board” can be integrated into the embodiments in a variety of manners.

“Casinos” are a public room or building where gambling games are played. “Racino” is a building complex or grounds having a racetrack and gambling facilities for playing slot machines, blackjack, roulette, etc. “Casino” and “Racino” can be integrated into the embodiments in a variety of manners.

Customers are companies, organizations or individuals that would deploy, for fees, and may be part of, or perform, various system elements or method steps in the embodiments.

Managed service user interface service is a service that can help customers (1) manage third parties, (2) develop the web, (3) perform data analytics, (4) connect thru application program interfaces and (4) track and report on player behaviors. A managed service user interface can be integrated into the embodiments in a variety of manners.

Managed service risk management service are services that assist customers with (1) very important person management, (2) business intelligence, and (3) reporting. These managed service risk management services can be integrated into the embodiments in a variety of manners.

Managed service compliance service is a service that helps customers manage (1) integrity monitoring, (2) play safety, (3) responsible gambling, and (4) customer service assistance. These managed service compliance services can be integrated into the embodiments in a variety of manners.

Managed service pricing and trading service is a service that helps customers with (1) official data feeds, (2) data visualization, and (3) land based on property digital signage. These managed service pricing and trading services can be integrated into the embodiments in a variety of manners.

Managed service and technology platforms are services that help customers with (1) web hosting, (2) IT support, and (3) player account platform support. These managed service and technology platform services can be integrated into the embodiments in a variety of manners.

Managed service and marketing support services are services that help customers (1) acquire and retain clients and users, (2) provide for bonusing options, and (3) develop press release content generation. These managed service and marketing support services can be integrated into the embodiments in a variety of manners.

Payment processing services are services that help customers with (1) account auditing and (2) withdrawal processing to meet standards for speed and accuracy. Further, these services can provide for integration of global and local payment methods. These payment processing services can be integrated into the embodiments in a variety of manners.

Engaging promotions allow customers to treat players to free bets, odds boosts, enhanced access, and flexible cashback to boost lifetime value. Engaging promotions can be integrated into the embodiments in a variety of manners.

“Cash out” or “pay out” or “payout” allow customers to make available, on singles bets or accumulated bets with a partial cash out where each operator can control payouts by always managing commission and availability. The “cash out” or “pay out” or “payout” can be integrated into the embodiments in a variety of manners, including both monetary and non-monetary payouts, such as points, prizes, promotional or discount codes, and the like.

“Customized betting” allows customers to have tailored personalized betting experiences with sophisticated tracking and analysis of players' behavior. “Customized betting” can be integrated into the embodiments in a variety of manners.

Kiosks are devices that offer interactions with customers, clients, and users with a wide range of modular solutions for both retail and online sports gaming. Kiosks can be integrated into the embodiments in a variety of manners.

Business Applications are an integrated suite of tools for customers to manage the everyday activities that drive sales, profit, and growth by creating and delivering actionable insights on performance to help customers to manage the sports gaming. Business Applications can be integrated into the embodiments in a variety of manners.

State-based integration allows for a given sports gambling game to be modified by states in the United States or other countries, based upon the state the player is in, mobile phone, or other geolocation identification means. State-based integration can be integrated into the embodiments in a variety of manners.

Game Configurator allows for configuration of customer operators to have the opportunity to apply various chosen or newly created business rules on the game as well as to parametrize risk management. The Game Configurator can be integrated into the embodiments in a variety of manners.

“Fantasy sports connectors” are software connectors between method steps or system elements in the embodiments that can integrate fantasy sports. Fantasy sports allow a competition in which participants select imaginary teams from among the players in a league and score points according to the actual performance of their players. For example, if a player in fantasy sports is playing at a given real-time sport, odds could be changed in the real-time sports for that player.

Software as a service (or SaaS) is a software delivery and licensing method in which software is accessed online via a subscription rather than bought and installed on individual computers. Software as a service can be integrated into the embodiments in a variety of manners.

Synchronization of screens means synchronizing bets and results between devices, such as TV and mobile, PC, and wearables. Synchronization of screens can be integrated into the embodiments in a variety of manners.

Automatic content recognition (ACR) is an identification technology that recognizes content played on a media device or present in a media file. Devices containing ACR support enable users to quickly obtain additional information about the content they see without any user-based input or search efforts. A short media clip (audio, video, or both) is selected to start the recognition. This clip could be selected from within a media file or recorded by a device. Through algorithms such as fingerprinting, information from the actual perceptual content is taken and compared to a database of reference fingerprints, wherein each reference fingerprint corresponds with a known recorded work. A database may contain metadata about the work and associated information, including complementary media. If the media clip's fingerprint is matched, the identification software returns the corresponding metadata to the client application. For example, during an in-play sports game, a “fumble” could be recognized and at the time stamp of the event, metadata such as “fumble” could be displayed. Automatic content recognition (ACR) can be integrated into the embodiments in a variety of manners.

Joining social media means connecting an in-play sports game bet or result to a social media connection, such as a FACEBOOK® chat interaction. Joining social media can be integrated into the embodiments in a variety of manners.

Augmented reality means a technology that superimposes a computer-generated image on a user's view of the real world, thus providing a composite view. In an example of this invention, a real time view of the game can be seen and a “bet”—which is a computer-generated data point—is placed above the player that is bet on. Augmented reality can be integrated into the embodiments in a variety of manners.

Some embodiments of this disclosure, illustrating all its features, will now be discussed in detail. It can be understood that the embodiments are intended to be open-ended in that an item or items used in the embodiments is not meant to be an exhaustive listing of such item or items or meant to be limited to only the listed item or items.

It can be noted that as used herein and in the appended claims, the singular forms “a,” “an,” and “the” include plural references unless the context clearly dictates otherwise. Although any systems and methods similar or equivalent to those described herein can be used in the practice or testing of embodiments, only some exemplary systems and methods are now described.

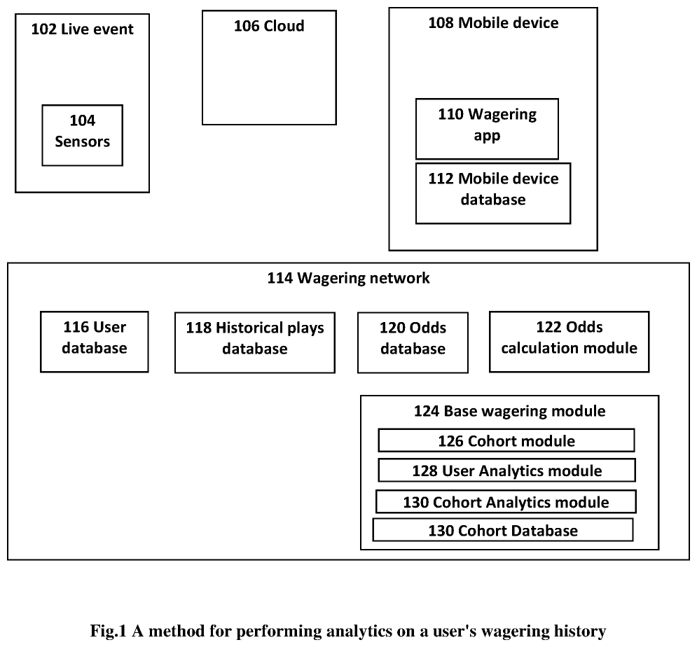

FIG. 1 is a method for performing analytics on a user's wagering history. This system may include a live event 102, for example, a sporting event such as a football, basketball, baseball, or hockey game, tennis match, golf tournament, eSports, or digital game, etc. The live event 102 may include some number of actions or plays, upon which a user, bettor, or customer can place a bet or wager, typically through an entity called a sportsbook. There are numerous types of wagers the bettor can make, including, but not limited to, a straight bet, a money line bet, or a bet with a point spread or line that the bettor's team would need to cover if the result of the game with the same as the point spread the user would not cover the spread, but instead the tie is called a push. If the user bets on the favorite, points are given to the opposing side, which is the underdog or longshot. Betting on all favorites is referred to as chalk and is typically applied to round-robin or other tournaments' styles. There are other types of wagers, including, but not limited to, parlays, teasers, and prop bets, which are added games that often allow the user to customize their betting by changing the odds and payouts received on a wager. Certain sportsbooks will allow the bettor to buy points which moves the point spread off the opening line. This increases the price of the bet, sometimes by increasing the juice, vig, or hold that the sportsbook takes. Another type of wager the bettor can make is an over/under, in which the user bets over or under a total for the live event 102, such as the score of an American football game or the run line in a baseball game, or a series of actions in the live event 102. Sportsbooks have several bets they can handle, limiting the number of wagers they can take on either side of a bet before they will move the line or odds off the opening line. Additionally, there are circumstances, such as an injury to an important player like a listed pitcher, in which a sportsbook, casino, or racino may take an available wager off the board. As the line moves, an opportunity may arise for a bettor to bet on both sides at different point spreads to middle, and win, both bets. Sportsbooks will often offer bets on portions of games, such as first-half bets and half-time bets. Additionally, the sportsbook can offer futures bets on live events in the future. Sportsbooks need to offer payment processing services to cash out customers which can be done at kiosks at the live event 102 or at another location.

Further, embodiments may include a plurality of sensors 104 that may be used such as motion, temperature, or humidity sensors, optical sensors, and cameras such as an RGB-D camera which is a digital camera capable of capturing color (RGB) and depth information for every pixel in an image, microphones, radiofrequency receivers, thermal imagers, radar devices, lidar devices, ultrasound devices, speakers, wearable devices, etc. Also, the plurality of sensors 104 may include but are not limited to, tracking devices, such as RFID tags, GPS chips, or other such devices embedded on uniforms, in equipment, in the field of play and boundaries of the field of play, or on other markers in the field of play. Imaging devices may also be used as tracking devices, such as player tracking, which provide statistical information through real-time X, Y positioning of players and X, Y, Z positioning of the ball.

Further, embodiments may include a cloud 106 or a communication network that may be a wired and/or wireless network. The communication network, if wireless, may be implemented using communication techniques such as visible light communication (VLC), worldwide interoperability for microwave access (WiMAX), long term evolution (LTE), wireless local area network (WLAN), infrared (IR) communication, public switched telephone network (PSTN), radio waves, or other communication techniques that are known in the art. The communication network may allow ubiquitous access to shared pools of configurable system resources and higher-level services that can be rapidly provisioned with minimal management effort, often over the Internet, and relies on sharing resources to achieve coherence and economies of scale, like a public utility. In contrast, third-party clouds allow organizations to focus on their core businesses instead of expending resources on computer infrastructure and maintenance. The cloud 106 may be communicatively coupled to a peer-to-peer wagering network 114, which may perform real-time analysis on the type of play and the result of the play. The cloud 106 may also be synchronized with game situational data such as the time of the game, the score, location on the field, weather conditions, and the like, which may affect the choice of play utilized. For example, in an exemplary embodiment, the cloud 106 may not receive data gathered from the sensors 104 and may, instead, receive data from an alternative data feed, such as Sports Radar®. This data may be compiled substantially immediately following the completion of any play and may be compared with a variety of team data and league data based on a variety of elements, including the current down, possession, score, time, team, and so forth, as described in various exemplary embodiments herein.

Further, embodiments may include a mobile device 108 such as a computing device, laptop, smartphone, tablet, computer, smart speaker, or I/O devices. I/O devices may be present in the computing device. Input devices may include but are not limited to, keyboards, mice, trackpads, trackballs, touchpads, touch mice, multi-touch touchpads and touch mice, microphones, multi-array microphones, drawing tablets, cameras, single-lens reflex cameras (SLRs), digital SLRs (DSLRs), complementary metal-oxide semiconductor (CMOS) sensors, accelerometers, IR optical sensors, pressure sensors, magnetometer sensors, angular rate sensors, depth sensors, proximity sensors, ambient light sensors, gyroscopic sensors, or other sensors. Output devices may include but are not limited to, video displays, graphical displays, speakers, headphones, inkjet printers, laser printers, or 3D printers. Devices may include, but are not limited to, a combination of multiple input or output devices such as, Microsoft KINECT, Nintendo Wii remote, Nintendo WII U GAMEPAD, or Apple iPhone. Some devices allow gesture recognition inputs by combining input and output devices. Other devices allow for facial recognition, which may be utilized as an input for different purposes such as authentication or other commands. Some devices provide for voice recognition and inputs including, but not limited to, Microsoft KINECT, SIRI for iPhone by Apple, Google Now, or Google Voice Search. Additional user devices have both input and output capabilities including but not limited to, haptic feedback devices, touchscreen displays, or multi-touch displays. Touchscreen, multi-touch displays, touchpads, touch mice, or other touch sensing devices may use different technologies to sense touch, including but not limited to, capacitive, surface capacitive, projected capacitive touch (PCT), in-cell capacitive, resistive, IR, waveguide, dispersive signal touch (DST), in-cell optical, surface acoustic wave (SAW), bending wave touch (BWT), or force-based sensing technologies. Some multi-touch devices may allow two or more contact points with the surface, allowing advanced functionality including, but not limited to, pinch, spread, rotate, scroll, or other gestures. Some touchscreen devices, including but not limited to, Microsoft PIXELSENSE or Multi-Touch Collaboration Wall, may have larger surfaces, such as on a table-top or on a wall, and may also interact with other electronic devices. Some I/O devices, display devices, or groups of devices may be augmented reality devices. An I/O controller may control one or more I/O devices, such as a keyboard and a pointing device, or a mouse or optical pen. Furthermore, an I/O device may also contain storage and/or an installation medium for the computing device. In some embodiments, the computing device may include USB connections (not shown) to receive handheld USB storage devices. In further embodiments, an I/O device may be a bridge between the system bus and an external communication bus, e.g., USB, SCSI, FireWire, Ethernet, Gigabit Ethernet, Fiber Channel, or Thunderbolt buses. In some embodiments, the mobile device 108 could be an optional component and would be utilized in a situation where a paired wearable device employs the mobile device 108 for additional memory or computing power or connection to the internet.

Further, embodiments may include a wagering software application or a wagering app 110, which is a program that enables the user to place bets on individual plays in the live event 102, streams audio and video from the live event 102, and features the available wagers from the live event 102 on the mobile device 108. The wagering app 110 allows the user to interact with the wagering network 114 to place bets and provide payment/receive funds based on wager outcomes.

Further, embodiments may include a mobile device database 112 that may store some or all the user's data, the live event 102, or the user's interaction with the wagering network 114.

Further, embodiments may include the wagering network 114, which may perform real-time analysis on the type of play and the result of a play or action. The wagering network 114 (or the cloud 106) may also be synchronized with game situational data, such as the time of the game, the score, location on the field, weather conditions, and the like, which may affect the choice of play utilized. For example, in an exemplary embodiment, the wagering network 114 may not receive data gathered from the sensors 104 and may, instead, receive data from an alternative data feed, such as SportsRadar®. This data may be provided substantially immediately following the completion of any play and may be compared with a variety of team data and league data based on a variety of elements, including the current down, possession, score, time, team, and so forth, as described in various exemplary embodiments herein. The wagering network 114 can offer several SaaS managed services such as user interface service, risk management service, compliance, pricing and trading service, IT support of the technology platform, business applications, game configuration, state-based integration, fantasy sports connection, integration to allow the joining of social media, or marketing support services that can deliver engaging promotions to the user.

Further, embodiments may include a user database 116, which may contain data relevant to all users of the wagering network 114 and may include, but is not limited to, a user ID, a device identifier, a paired device identifier, wagering history, or wallet information for the user. The user database 116 may also contain a list of user account records associated with respective user IDs. For example, a user account record may include, but is not limited to, information such as user interests, user personal details such as age, mobile number, etc., previously played sporting events, highest wager, favorite sporting event, or current user balance and standings. In addition, the user database 116 may contain betting lines and search queries. The user database 116 may be searched based on a search criterion received from the user. Each betting line may include but is not limited to, a plurality of betting attributes such as at least one of the following: the live event 102, a team, a player, an amount of wager, etc. The user database 116 may include, but is not limited to, information related to all the users involved in the live event 102. In one exemplary embodiment, the user database 116 may include information for generating a user authenticity report and a wagering verification report. Further, the user database 116 may be used to store user statistics like, but not limited to, the retention period for a particular user, frequency of wagers placed by a particular user, the average amount of wager placed by each user, etc.

Further, embodiments may include a historical plays database 118 that may contain play data for the type of sport being played in the live event 102. For example, in American Football, for optimal odds calculation, the historical play data may include metadata about the historical plays, such as time, location, weather, previous plays, opponent, physiological data, etc.

Further, embodiments may utilize an odds database 120—that may contain the odds calculated by an odds calculation module 122—to display the odds on the user's mobile device 108 and take bets from the user through the mobile device wagering app 110.

Further, embodiments may include the odds calculation module 122, which may utilize historical play data to calculate odds for in-play wagers.

Further, embodiments may include a base module 124, which initiates the cohort module 126, the user analytics module 128, and the cohort analytics module 130.

Further, embodiments may include a cohort module 126, which may extract the first user wagering history in the user database 116. For example, the user database 116 may contain the user ID, a device identifier, a paired device identifier, wagering history, or wallet information for the user. Then the cohort module 126 may compare the extracted user wager history to the cohort database 132. For example, if the user places ten wagers per week, the user may be placed in cohort one since the requirement for cohort one is that the user places between five and twenty wagers a week. Another example may be if the user places 30 wagers a week, then the user may be placed in cohort two since the requirement for cohort two is that the user places between 21 and 49 wagers per week. In some embodiments, the cohorts may be determined by the number wagers of placed by a user, the amount of money wagered by the user, the amount of time spent on the wagering application or wagering platform, the number of friends the user has on the wagering application or wagering platform, the amount of research the user performs on the wagering application or wagering platform, or any combination thereof. The cohort module 126 may extract the corresponding cohort. For example, the cohort module 126 may extract the cohort number, such as 1, from the cohort database 132. Then the cohort module 126 may store the extracted cohort in the user database 116. For example, the cohort module 126 may store cohort 1 in the user database 116. The cohort module 126 may determine if more users are remaining in the user database 116. For example, the cohort module 126 may go through each user in the user database 116 to give a cohort for each user. If there are more users in the user database 116, then the cohort module may extract the next user's wagering history in the user database 116, and the process may return to comparing the wagering history to the cohort database 132. If there are no more users remaining in the user database 116, then the cohort module 126 may return to the base module 124.

Further, embodiments may include a user analytics module 128, which may continuously poll for the user to select a wager, and then the user may select a wager. The user analytics module 128 may filter the user database 116 for the selected wager market and the user ID. Then the user analytics module 128 may analyze the user's wager history from the filtered user database 116 and display the user's wager history percentage on the wagering app 110. Then the user analytics module 128 may return to the base module 124.

Further, embodiments may include a cohort analytics module 130 that may continuously poll for the user to select a wager, and then the user may select a wager. The cohort analytics module 130 may filter the user database 116 for the selected wager market and the user cohort, and then the cohort analytics module 130 may analyze the cohort's wager history from the filtered user database 116. The cohort analytics module 130 may display the cohort's wager history percentage on the wagering app 110, and the cohort analytics module 130 may return to the base module 124.

Further, embodiments may include a cohort database 132, which may contain the cohort, such as 1, 2, 3, etc. and the requirement for the user to be placed in that cohort, such as the user places 5-20 wagers a week; the user places 21-49 wagers a week, the user places 50 or more wagers a week. The cohort database 132 may be used in the process described in the cohort module 126 to place users in cohorts that represent their skill level for the wagering app 110. In some embodiments, the cohort database 132 requirements may use historical wagering patterns over a day, week, month, year, etc. In some embodiments, the cohort database 132 requirements may be based on a monetary value, such as the more money spent by a user, the higher the cohort. In some embodiments, the cohorts may be determined by the number wagers of placed by a user, the amount of money wagered by the user, the amount of time spent on the wagering application or wagering platform, the number of friends the user has on the wagering application or wagering platform, the amount of research the user performs on the wagering application or wagering platform, or any combination thereof.

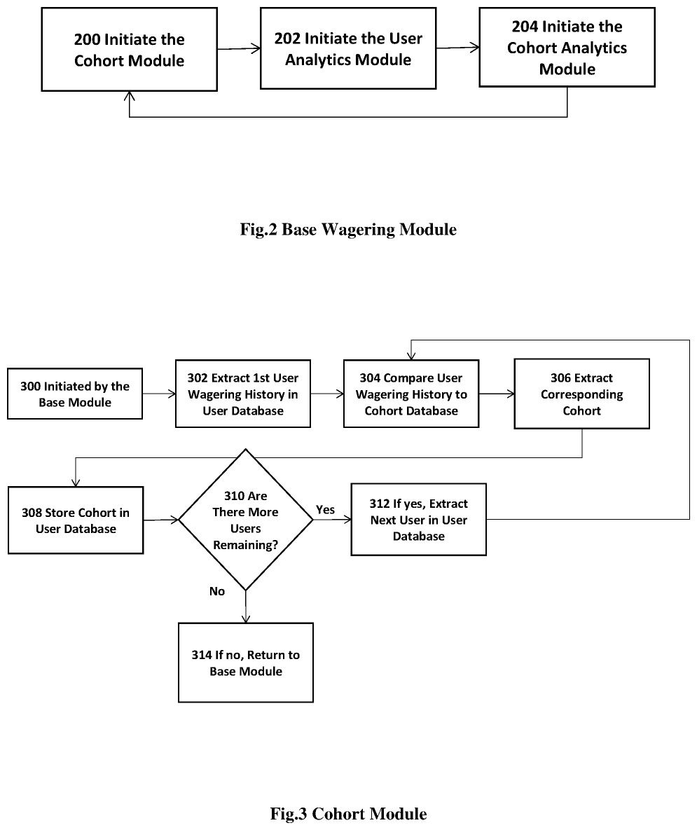

FIG. 2 illustrates the base module 124. The process may begin with the base module 124 initiating, at step 200, the cohort module 126. For example, the cohort module 126 may extract the first user wagering history in the user database 116. For example, the user database 116 may contain the user ID, a device identifier, a paired device identifier, wagering history, or wallet information for the user. Then the cohort module 126 may compare the extracted user wager history to the cohort database 132. For example, if the user places ten wagers per week, the user may be placed in cohort one since the requirement for cohort one is that the user places between 5 and 20 wagers a week. Another example may be if the user places 30 wagers a week, then the user may be placed in cohort two since the requirement for cohort two is that the user places between 21 and 49 wagers per week. In some embodiments, the cohorts may be determined by the number wagers of placed by a user, the amount of money wagered by the user, the amount of time spent on the wagering application or wagering platform, the number of friends the user has on the wagering application or wagering platform, the amount of research the user performs on the wagering application or wagering platform, or any combination thereof. The cohort module 126 may extract the corresponding cohort. For example, the cohort module 126 may extract the cohort number, such as 1, from the cohort database 132. Then the cohort module 126 may store the extracted cohort in the user database 116. For example, the cohort module 126 may store cohort 1 in the user database 116. Then the cohort module 126 may determine if more users are remaining in the user database 116. For example, the cohort module 126 may go through each user in the user database 116 to assign a cohort to each user. If there are more users in the user database 116, then the cohort module 126 may extract the next users wagering history from the user database 116, and the process may return to comparing the wagering history to the cohort database 132. If there are no more users remaining in the user database 116, then the cohort module 126 may return to the base module 124. Then the base module 124 may initiate, at step 202, the user analytics module 128. For example, the user analytics module 128 may continuously poll for the user to select a wager, and then the user may select a wager. The user analytics module 128 may filter the user database 116 for the selected wager market and the user ID. Then the user analytics module 128 may analyze the user's wager history from the filtered user database 116 and display the user's wager history percentage on the wagering app 110. Then the user analytics module 128 may return to the base module 124. Then the base module 124 may initiate, at step 204, the cohort analytics module 130. For example, the cohort analytics module 130 may continuously poll for the user to select a wager, and then the user may select a wager. The cohort analytics module 130 may filter the user database 116 for the selected wager market and the user cohort, and then the cohort analytics module 130 may analyze the cohort's wager history from the filtered user database 116. The cohort analytics module 130 may display the cohort's wager history percentage on the wagering app 110, and the cohort analytics module 130 may return to the base module 124.

FIG. 3 illustrates the cohort module 126. The process may begin with the cohort module 126 being initiated, at step 300, by the base module 124. The cohort module 126 may extract, at step 302, a first user wagering history in the user database 116. For example, the user database 116 may contain the user ID, a device identifier, a paired device identifier, wagering history, or wallet information for the user. Then the cohort module 126 may compare, at step 304, the extracted user wager history to the cohort database 132. For example, if the user places ten wagers per week, the user may be placed in cohort one since the requirement for cohort one is that the user places between 5 and 20 wagers a week. Another example may be if the user places 30 wagers a week, then the user may be placed in cohort two since the requirement for cohort two is that the user places between 21 and 49 wagers per week. In some embodiments, the cohorts may be determined by the number wagers of placed by a user, the amount of money wagered by the user, the amount of time spent on the wagering application or wagering platform, the number of friends the user has on the wagering application or wagering platform, the amount of research the user performs on the wagering application or wagering platform, or any combination thereof. The cohort module 126 may extract, at step 306, the corresponding cohort. For example, the cohort module 126 may extract the cohort number, such as 1, from the cohort database 132. Then the cohort module 126 may store, at step 308, the extracted cohort in the user database 116. For example, the cohort module 126 may store cohort 1 in the user database 116. The cohort module 126 may determine, at step 310, if more users remain in the user database 116. For example, the cohort module 126 may go through each user in the user database 116 to assign a cohort to each user. If more users remain in the user database 116, then the cohort module may extract, at step 312, the next users wagering history in the user database 116, and the process may return to comparing the wagering history to the cohort database 132 at step 304. If there are no more users remaining in the user database 116, then the cohort module 126 may return, at step 314, to the base module 124.

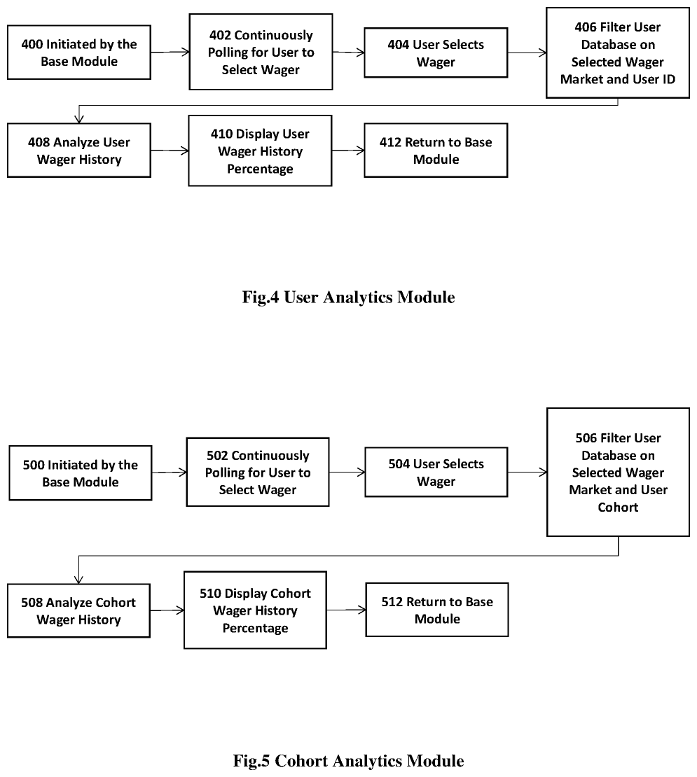

FIG. 4 illustrates the user analytics module 128. The process may begin with the user analytics module 128 being initiated, at step 400, by the base module 124. The user analytics module 128 may continuously poll, at step 402, for the user to select a wager. For example, the user may select a wager, such as the first pitch in the Boston Red Sox vs. New York Yankees event will be a strike. Then the user may select, at step 404, a wager. For example, the user may select a wager, such as the first pitch in the Boston Red Sox vs. New York Yankees event will be a strike. The user analytics module 128 may filter, at step 406, the user database 116 for the selected wager market and the user ID. For example, the user database 116 may be filtered for the user ID, such as JS12345, and the wagering market of the first pitch in events, including the Boston Red Sox vs. New York Yankees. The markets with those common characteristics may be further narrowed to only include instances in which the user wagered the pitch being a strike. In some embodiments, the user database 116 may be filtered for every instance the user wagered on a baseball event where they wagered that the first pitch would be a strike. Then the user analytics module 128 may analyze, at step 408, the user's wager history from the filtered user database 116. For example, the user analytics module 128 may determine the number of successful wagers and divide the successful attempts by the number of times the user wagered on the first pitch being a strike in an event, including the Boston Red Sox vs. the New York Yankees. For example, if the user successfully wagered six instances of the first pitch being a strike in an event including the Boston Red Sox vs. the New York Yankees and the total number of instances that the user had placed this wager was 10, then the user's wagering history percentage may be 60% successful. Another example may be if the user selected for the Boston Red Sox's J. D. Martinez to hit a single in an event against the Tampa Rays, then the user database 116 may be filtered for every instance that the user had wagered on the Boston Red Sox's J. D. Martinez to hit a single in an event against the Tampa Rays. Then the user analytics module 128 may determine the number of instances in which the user was successful in wagering that the Boston Red Sox's J. D. Martinez hit a single in an event against the Tampa Rays and determine the total number of instances that the user had wagered the Boston Red Sox's J. D. Martinez to hit a single in an event against the Tampa Rays. Then the user analytics module 128 may divide the successful instances by the total instances to determine the user's wager history percentage, success rate, or success percentage. In another embodiment, success rate could also be determined as a measure of profitability of wagers of a user (or cohort), as desired. For example, if the user had successfully wagered ten times that the Boston Red Sox's J. D. Martinez to hit a single in an event against the Tampa Rays and the total amount of instances that the user wagered that the Boston Red Sox's J. D. Martinez to hit a single in an event against the Tampa Rays was 50, then the user's wagering history percentage, success rate or success percentage may be 20%. The user analytics module 128 may display, at step 410, the user's wager history percentage on the wagering app 110. For example, if the user successfully wagered six instances of the first pitch being a strike in an event including the Boston Red Sox vs. the New York Yankees and the total number of instances that the user had placed this wager was 10, then the user's wagering history percentage may be 60% successful. The user's wager history percentage of 60% successful may be displayed on the wagering app 110 before the user confirms a wager but after the user selects a wager. Another example may be if the user had successfully wagered ten times that the Boston Red Sox's J. D. Martinez to hit a single in an event against the Tampa Rays and the total amount of instances that the user wagered that the Boston Red Sox's J. D. Martinez to hit a single in an event against the Tampa Rays was 50, then the user's wagering history percentage, success rate or success percentage may be 20% and this may be displayed on the wagering app 110. In some embodiments, the successful wager percentage may be displayed before the user selects the wager by determining the user's successful wager percentage for every wager displayed on the wagering app 110 within the wagering market displayed. Then the user analytics module 128 may return, at step 412, to the base module 124.

FIG. 5 illustrates the cohort analytics module 130. The process may begin with the cohort analytics module 130 being initiated, at step 500, by the base module 124. The cohort analytics module 130 may continuously poll, at step 502, for the user to select a wager. For example, the user may select a wager, such as the first pitch in the Boston Red Sox vs. New York Yankees event will be a strike. Then the user may select, at step 504, a wager. For example, the user may select a wager, such as the first pitch in the Boston Red Sox vs. New York Yankees event will be a strike. The cohort analytics module 130 may filter, at step 506, the user database 116 for the selected wager market and the user cohort. For example, the user database 116 may be filtered for the user's cohort, such as cohort 1, and the wagering market of the first pitch in events, including the Boston Red Sox vs. New York Yankees in which the user wagered the pitch will be a strike. In some embodiments, the user database 116 may be filtered for every instance the cohort wagered on a baseball event where they wagered that the first pitch would be a strike. Then the cohort analytics module 130 may analyze, at step 508, the cohort's wager history from the filtered user database 116. For example, the cohort analytics module 130 may determine the number of successful wagers and divide the successful attempts by the number of times the cohort wagered on the first pitch being a strike in an event, including the Boston Red Sox vs. the New York Yankees. For example, if the users in the cohort successfully wagered 50 instances of the first pitch being a strike in an event including the Boston Red Sox vs. the New York Yankees and the total number of instances that the cohort had placed this wager was 100, then the users in the cohort wagering history percentage may be 50% successful. Another example may be if the user selected for the Boston Red Sox's J. D. Martinez to hit a single in an event against the Tampa Rays, then the user database 116 may be filtered for every instance that the users in the same cohort had wagered on the Boston Red Sox's J. D. Martinez to hit a single in an event against the Tampa Rays. Then the cohort analytics module 130 may determine the number of instances in which the users in the cohort were successful in wagering that the Boston Red Sox's J. D. Martinez hit a single in an event against the Tampa Rays and determine the total number of instances that the user had wagered the Boston Red Sox's J. D. Martinez to hit a single in an event against the Tampa Rays. Then the cohort analytics module 130 may divide the successful instances by the total instances to determine the cohort wager history percentage, success rate, or success percentage. For example, if the users in the cohort had successfully wagered 200 times that the Boston Red Sox's J. D. Martinez to hit a single in an event against the Tampa Rays and the total amount of instances that the users in the cohort wagered that the Boston Red Sox's J. D. Martinez to hit a single in an event against the Tampa Rays was 500, then the users in the cohort wagering history percentage, success rate or success percentage may be 40%. The cohort analytics module 130 may display, at step 510, the cohort's wager history percentage on the wagering app 110. The display may be on a user device, devices of users in the cohort, or on a device or application associated with a sportsbook or the wagering network, who may, for example, use this information to perform further analytics or otherwise adjust available wagers or features on a wagering network. For example, if the users in the cohort successfully wagered 50 instances of the first pitch being a strike in an event including the Boston Red Sox vs. the New York Yankees and the total number of instances that the cohort had placed this wager was 100, then the users in the cohort wagering history percentage may be 50% successful. The cohort's wager history percentage of being 50% successful may be displayed on the wagering app 110 (or another device or application associated with a sportsbook or wagering network) before the user confirms a wager but after the user selects a wager. Another example may be if the users in the cohort had successfully wagered 200 times that the Boston Red Sox's J. D. Martinez to hit a single in an event against the Tampa Rays and the total amount of instances that the users in the cohort wagered that the Boston Red Sox's J. D. Martinez to hit a single in an event against the Tampa Rays was 500, then the users in the cohort wagering history percentage, success rate or success percentage may be 40%. This 40% wagering history percentage may be displayed on the wagering app 110 (or may be made available to a device associated with a sportsbook administrator, wagering network, or skilled game operator (SGO), as desired). In some embodiments, the successful wager percentage may be displayed before the user selects a wager by determining the cohort's successful wager percentage for every wager displayed on the wagering app 110 within the wagering market displayed. Then the cohort analytics module 130 may return, at step 512, to the base module 124. Alternatively and further, the successful wager information or other wager analytics of a user or cohort may be displayed on a device or application associated with a sportsbook or otherwise associated with the wagering network.

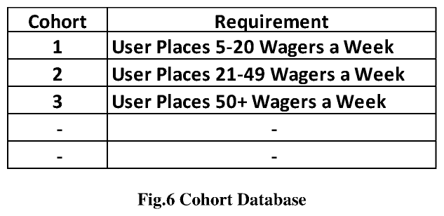

FIG. 6 illustrates the cohort database 132. The cohort database 132 may contain the cohort, such as 1, 2, 3, etc. and the requirement for the user to be placed in that cohort, such as the user places 5-20 wagers a week; the user places 21-49 wagers a week, the user places 50 or more wagers a week. The cohort database 132 may be used in the process described in the cohort module 126 to place users in cohorts that represent their skill level for the wagering app 110. In some embodiments, the cohort database 132 requirements may use historical wagering patterns over a day, week, month, year, etc. In some embodiments, the cohort database 132 requirements may be based on a monetary value, such as the more money spent by a user, the higher the cohort. In some embodiments, the cohorts may be determined by the number wagers of placed by a user, the amount of money wagered by the user, the amount of time spent on the wagering application or wagering platform, the number of friends the user has on the wagering application or wagering platform, the amount of research the user performs on the wagering application or wagering platform, or any combination thereof.

The foregoing description and accompanying figures illustrate the principles, preferred embodiments, and modes of operation of the invention. However, the invention should not be construed as being limited to the embodiments discussed above. Additional variations of the embodiments discussed above will be appreciated by those skilled in the art.

Therefore, the above-described embodiments should be regarded as illustrative rather than restrictive. Accordingly, it should be appreciated that variations to those embodiments can be made by those skilled in the art without departing from the scope of the invention as defined by the following claims.

1. A method for performing analytics on wagering history of a user and a cohort on a wagering network, the method comprising:
receiving a wager selected by the user, wherein the user has been assigned to the cohort;
storing a wagering history of the user and the cohort in a database;
analyzing the wagering history of the user in the database;
analyzing the wagering history of the cohort in the database;
determining a historical wagering success rate of the user and the cohort; and
displaying, with the selected wager, the historical wagering success rate of the user and the cohort on an application or device before the user confirms the selected wager.

2. The method for performing analytics on the wagering history of the user and the cohort on the wagering network of claim 1, further comprising:
a cohort database which lists requirements to be assigned to the cohort.

3. The method for performing analytics on the wagering history of the user and the cohort on the wagering network of claim 2, wherein the requirements to be assigned to the cohort comprise:
at least one of a predetermined number of wagers over a period, a monetary value, an amount of time spent on a wagering application or platform, and an amount of research performed by the user on the wagering application or platform.

4. The method for performing analytics on the wagering history of the user and the cohort on the wagering network of claim 2, wherein the user has been assigned to the cohort by comparing the wagering history of the user to the cohort database.

5. The method for performing analytics on the wagering history of the user and the cohort on the wagering network of claim 4, wherein the wagering history comprises at least one user ID, at least one device identifier, at least one paired device identifier, or wallet information of the user.

6. The method for performing analytics on the wagering history of the user and the cohort on the wagering network of claim 1, further comprising:
calculating the historical wagering success rate by filtering a user database for successful wager attempts; and
dividing the successful wager attempts by a total number of times the user or the cohort wagered on a specific event or total events.

7. The method for performing analytics on the wagering history of the user and the cohort on the wagering network of claim 1, further comprising:
displaying the historical wagering success rate to an application or device via a notification.

8. A system for performing analytics on wagering history of a user and a cohort on a wagering network, comprising executing steps to perform the analytics, on a processor configured to
receive a wager selected by the user, wherein the user has been assigned to the cohort;
analyze and display wagering history of the user; and
analyze and display wagering history of the cohort;
a user database configured to store the wagering history and a cohort number of the user;
a cohort database configured to store the cohort number of the user and a cohort requirement; and
a device or application configured to display, with the selected wager, a notification of a wagering success rate of the user before the user confirms the selected wager.

9. The system for performing analytics on the wagering history of the user and the cohort on the wagering network of claim 8, wherein the processor is further configured to extract and compare the wagering history of the user to the cohort database to determine that the wagering history of the user meets or exceeds a threshold requirement and store the cohort in the user database.

10. The system for performing analytics on the wagering history of the user and the cohort on the wagering network of claim 8, wherein the processor is further configured to calculate the wagering success rate of the user by filtering the user database for successful wagers, adding up the successful wagers, and dividing a number of successful wagers by a total amount of wagers for the event or total events.

11. The system for performing analytics on the wagering history of the user and the cohort on the wagering network of claim 8, wherein the processor is further configured to calculate a wagering success rate of the cohort by filtering the user database for successful wagers, adding up the successful wagers, and dividing a number of successful wagers by a total amount of wagers for the event or total events.

12. The system for performing analytics on the wagering history of the user and the cohort on the wagering network of claim 10, wherein the processor is further configured to display the wagering success rate of the user via at least one notification or message to the device or application.

13. The system for performing analytics on the wagering history of the user and the cohort on the wagering network of claim 11, wherein the processor is further configured to display the wagering success rate of the cohort via at least one notification or message to the device or application.

14. The system for performing analytics on the wagering history of the user and the cohort on the wagering network of claim 8, wherein the requirements in the cohort database are configured to be at least one predetermined number of wagers over a period, a monetary value, an amount of time spent on a wagering application or platform, and an amount of research performed by the user on the wagering application or platform.
